(19) United States
(12) Patent Application Publication
(10) Pub. No.: US 2018/0111686 A1
(43) Pub. Date: Apr. 26, 2018

(54) EJECTION PROTECTION BLACK BOX SYSTEM AND METHOD

(71) Applicant: Kathy Nixon, Detroit, MI (US)

(72) Inventor: Kathy Nixon, Detroit, MI (US)

(21) Appl. No.: 15/331,819

(22) Filed: Oct. 22, 2016

(51) Int. Cl. B64D 1/02; B64D 17/22; B64D 45/00

(52) U.S. Cl. CPC B64D 1/02; B64D 2045/0065; B64D 45/00; B64D 17/22

(57) ABSTRACT

The ejection protection black box is a device that is wired to the computers and engines of an aircraft. The ejection protection black box is able to detect any malfunction that may cause an airplane to crash. In the event of a malfunction, the black box will automatically eject from a chute located on the aircraft safely before impact. The ejection protection black box is further equipped to detect missiles or bombs that may be headed towards an aircraft.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of flight recorders and more specifically relates to an ejection protection black box system.

### 2. Description of Related Art

An airplane is a powered, fixed-wing aircraft that is propelled forward by thrust from a jet engine or propeller. Airplanes come in a variety of sizes, shapes, and wing configurations. The broad spectrum of uses for airplanes includes recreation, transportation of goods and people, military, and research. Commercial aviation is a massive industry involving the flying of tens of thousands of passengers daily on airliners. Most airplanes are flown by a pilot on board the aircraft, but some are designed to be remotely or computer-controlled.

An aviation accident is an occurrence associated with the operation of an aircraft, which takes place between the time any person boards the aircraft with the intention of flight until all such persons have disembarked, where a person is fatally or seriously injured, the aircraft sustains damage or structural failure or the aircraft is missing or is completely inaccessible. If the aircraft is destroyed or severely damaged so that it must be written off, it is further defined as a hull loss accident. Unfortunately, under various circumstances, airplanes may crash or an aviation incident will occur. Sometimes questions of why these incidents occur may go unanswered. A suitable solution is desired.

Several attempts have been made to solve the above-mentioned problems such as those found in U.S. Patent and Publication Nos. U.S. Pat. No. 8,489,259; 2012/0166037; and U.S. Pat. No. 6,373,521. This art is representative of flight recorders. However, none of the above inventions and patents, taken either singly or in combination, is seen to describe the invention as claimed.

### BRIEF SUMMARY OF THE INVENTION

In view of the foregoing disadvantages inherent in the known flight recording means art, the present invention provides a novel ejection protection black box system. The general purpose of the present invention, which will be described subsequently in greater detail, is to provide an effective means for detecting airplane malfunctions as well as missiles or explosive devices heading towards an aircraft.

An ejection protection black box system is disclosed herein, in a preferred embodiment, comprising: an ejection protection black box assembly including a black box, a parachute assembly having a canopy, and a plurality of suspension lines, a beacon, at least one powerer, and a motor; wherein the ejection protection black box assembly comprises in functional combination the black box removably couplable to the parachute assembly, the at least one powerer, the beacon, and the motor in functional combination.

The parachute assembly comprises the canopy connected to the plurality of suspension lines; the plurality of suspension lines connecting to the black box; wherein the black box is sealed to be waterproof and fireproof. The at least one powered (battery), and the motor are coupled under the canopy. The battery is rechargeable during non-use periods. In certain embodiments the present invention may have a fan that is able to be powered by the motor such that the device can be suspended for a duration to place it in a desired positioning when landing.

The parachute assembly is packed during a non-use condition and deployed when an in-use condition; wherein the parachute assembly is configured to slow motion of the ejection protection black box assembly when in the in-use condition after being ejected from a host aircraft; wherein the host aircraft comprises an ejection-port, the ejection-port is located adjacent an exterior of the host aircraft. The ejection-port preferably comprises a trap door located on a bottom side of the host aircraft.

The ejection protection black box assembly is in wired communication with computers of the host aircraft before ejection; the ejection prompted by a signaled communication of a threshold being reached by the host aircraft; the ejection protection black box assembly when ejected able to safely land a distance separate from the host aircraft should host aircraft crash the ejection protection black box assembly is preserved for review. The threshold is reached by the host aircraft is related to a measure of a sensed malfunction; wherein the sensed malfunction is sensed via at least one sensor. The black box is remotely located from the host aircraft after the host aircraft once ejection is caused by the at least one sensor.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present disclosure, ejection protection black box system, constructed and operative according to the teachings of the present disclosure.

FIG. 1 shows a perspective view illustrating an ejection protection black box system during an ‘in-use’ condition according to an embodiment of the disclosure.

FIG. 2 is a perspective view illustrating the ejection protection black box system comprising an ejection protection black box assembly according to an embodiment of the present invention of the disclosure.

FIG. 3 is a perspective view illustrating the ejection protection black box assembly according to an embodiment of the present disclosure.

FIG. 4 is a perspective view illustrating the ejection protection black box assembly according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a flight recorders and more particularly to a ejection protection black box system as used to improve the efficiency of retrieval of black boxes.

Generally speaking, ejection protection black box may be coupled to a parachute for when the device is ejected from an aircraft. The ejection protection black box may be in wired communication with the computers/sensors and/or engines of an aircraft. The ejection protection black box is able to detect any malfunction that may cause an airplane to crash. In the event of a malfunction, the ejection protection black box may automatically eject from the aircraft safely before impact. The ejection protection black box may comprise a parachute for safe landing. The ejection protection black box may further be equipped to detect missiles or bombs that may be headed towards an aircraft. The ejection protection black box may comprise a motor, which in functional combination with the parachute, may allow the device to safely reach land or water.

The ejection protection black box is an electronic recording device placed in an aircraft for the purpose of facilitating the investigation of aviation accidents and incidents. The device comprises a beacon, which may alert the aircraft recovery team of where the aircraft or plane was impacted or where the plane crashed. The ejection protection black box eliminates the need to search for a black box after an aircraft accident. The ejection protection black box further comprises a motor (or other suitable means) or battery under the parachute used for the safe landing of the ejection protection black box upon impact. The ejection protection black box may be fireproof and waterproof.

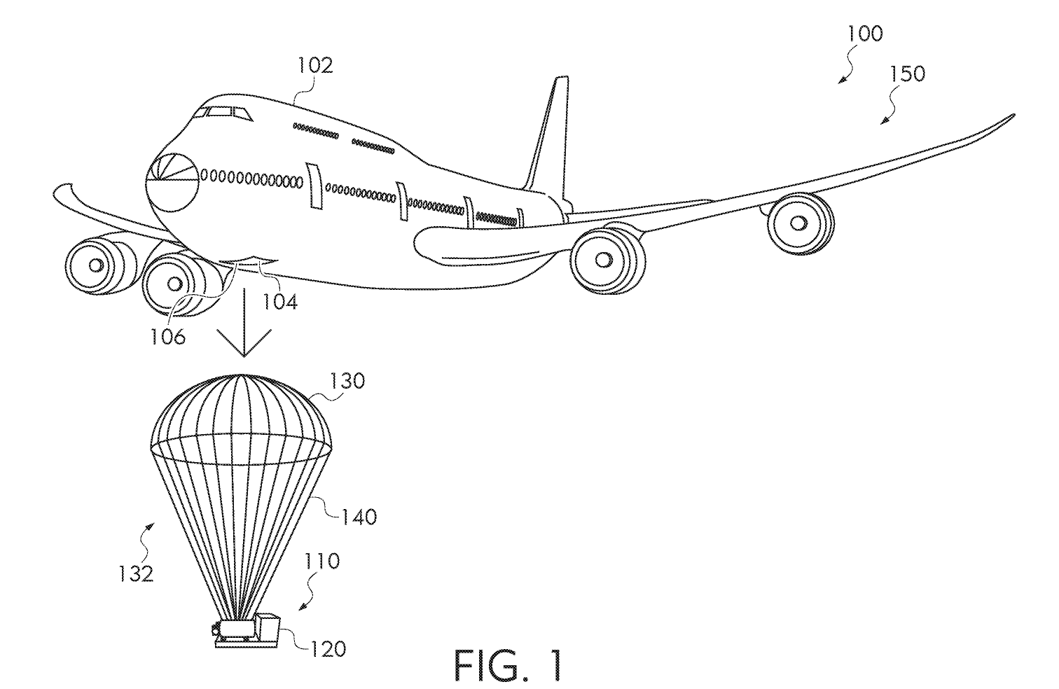

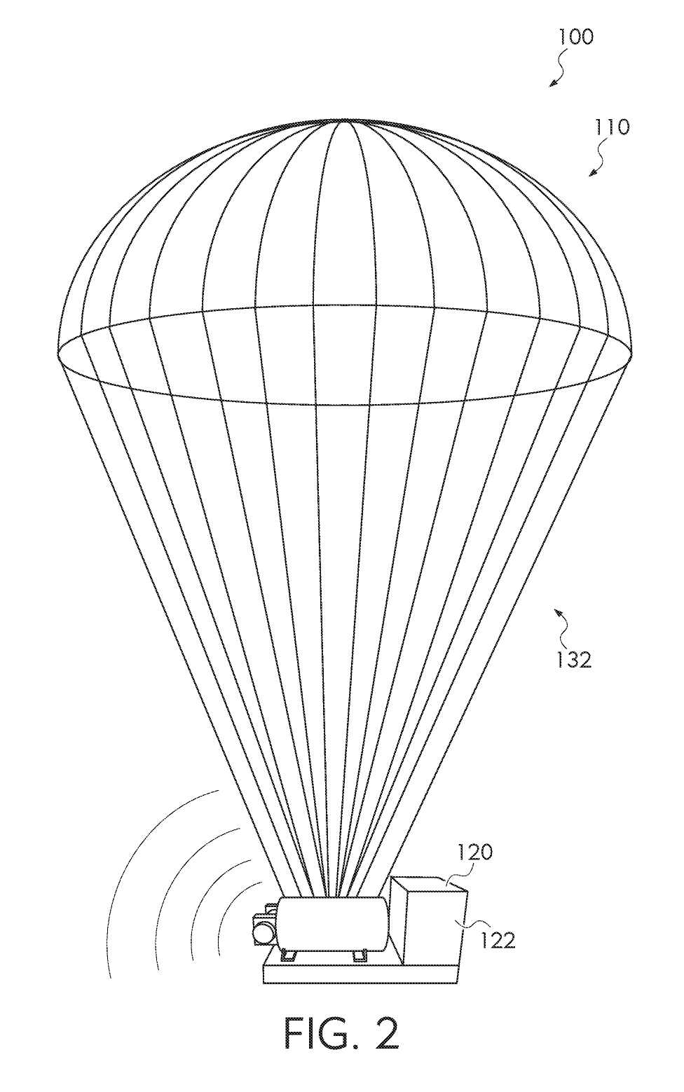

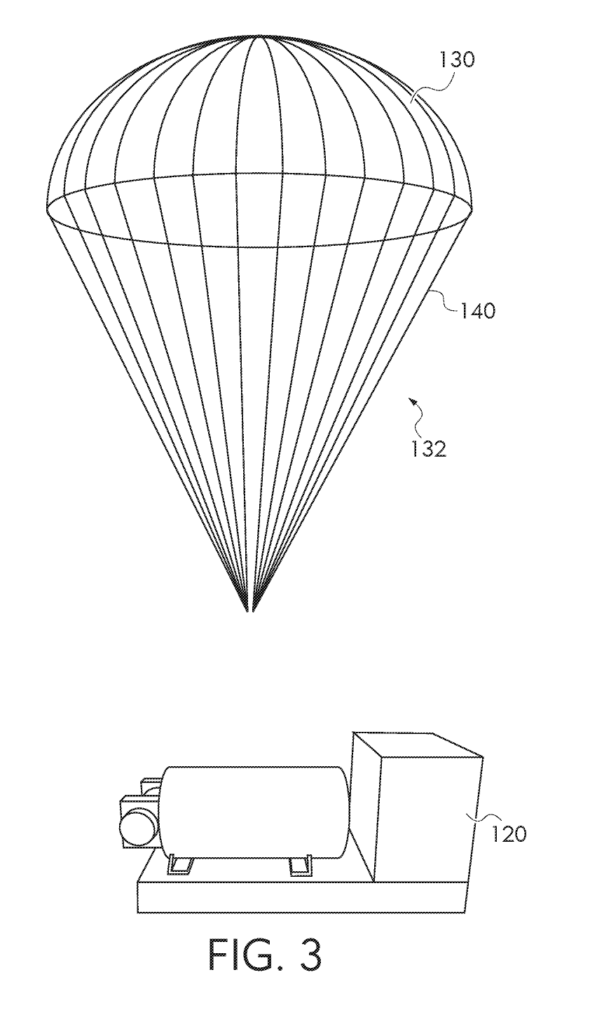

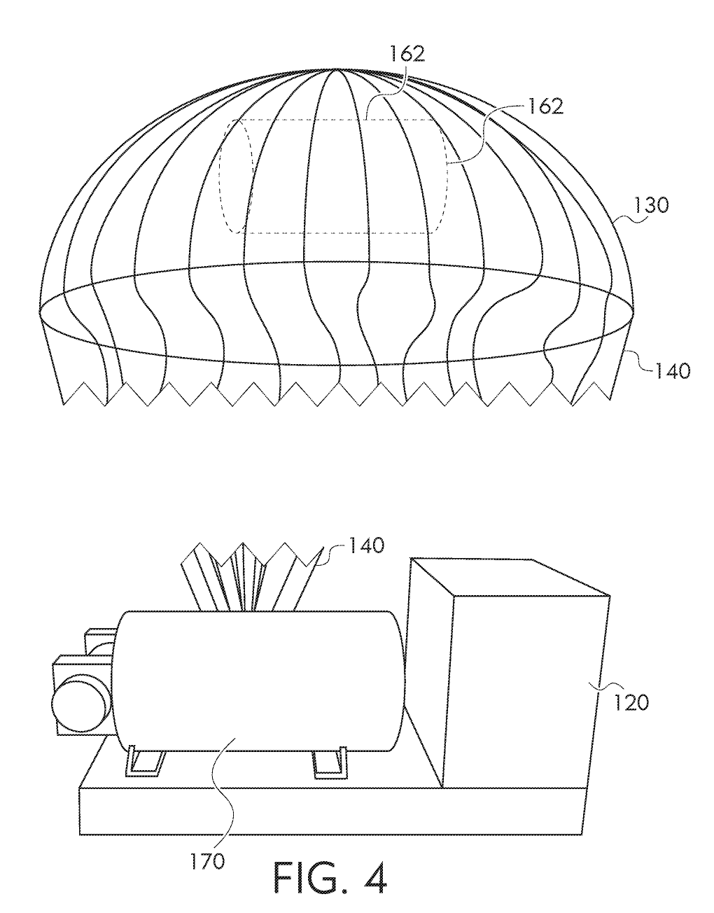

Referring now more specifically to the drawings by numerals of reference there is shown in FIGS. 1-4, various views of ejection protection black box system 100 comprising ejection protection black box assembly 110 including black box 120, parachute assembly 132 having canopy 130, and a plurality of suspension lines 140, at least one powerer 160, and motor 170; wherein ejection protection black box assembly 110 comprises in functional combination black box 120 removably couplable to parachute assembly 132, the at least one powerer 160, and motor 170 in functional combination. FIG. 1 shows an ‘in-use’ condition 150.

Parachute assembly 132 comprises canopy 130 connected to the plurality of suspension lines 140; the plurality of suspension lines 140 connecting to black box 120. The at least one powerer 160, and motor 170 are coupled under canopy 130 in preferred embodiments. Parachute assembly 132 is packed during a non-use condition and deployed when an in-use condition. Parachute assembly 132 is configured (when caused to be deployed) to slow motion of ejection protection black box assembly 110 when in the in-use condition after being ejected from host aircraft 102 and falling under controlled conditions to the earth below.

Ejection protection black box assembly 110 is in wired communication with computers of host aircraft 102 before ejection (non-use condition); the ejection prompted by a signaled communication of a threshold being reached by host aircraft 102. The threshold being reached by host aircraft 102 is related to a measure of a sensed malfunction. Ejection protection black box assembly 110 when ejected is able to safely land a distance separate from host aircraft 102 should host aircraft 102 crash ejection protection black box assembly 110 is preserved for review.

Ejection protection black box assembly 110 is structured, arranged and equipped to detect approaching missiles, and equipped to detect bombs approaching host aircraft 102 or brought on board host aircraft 102. Those with ordinary skill in the art will now appreciate that upon reading this specification and by their understanding the art of early detection of approaching or onboard bombs/explosives as described herein, methods of detection via sensors will be understood by those knowledgeable in such art. Ejection protection black box assembly 110 comprises beacon 122. Black box 120 is sealed to be waterproof and is fireproof via suitable means known in the art.

Host aircraft 102 comprises ejection-port 104; wherein ejection-port 104 is located adjacent an exterior of host aircraft 102 so as to minimize ejection time required. Ejection-port 104 may comprise a hinged or otherwise openable trap door 106 (shown in FIG. 1) located on a bottom side of host aircraft 102. The sensed malfunction is sensed via at least one sensor; wherein the at least one sensor measures cabin pressure, a sudden drop in elevation, a sudden drop in oil pressure, a sudden temperature increase, a sudden momentum decrease of host aircraft 102. Battery 162 comprises powerer 160 and is rechargeable during non-use periods. Black box 120 is remotely located from host aircraft 102 after host aircraft 102 once ejection is caused by the at least one sensor (sensing means).

Ejection protection black box system 100 may be sold as a kit comprising the following parts: at least one ejection protection black box assembly 110; at least one ejection-port 104; and at least one set of user instructions. The kit has instructions such that functional relationships are detailed in relation to the structure of the invention (such that the invention can be used, maintained, or the like in a preferred manner).

Ejection protection black box system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different sensing combinations, parts may be sold separately, etc., may be sufficient.

A method of use for ejection protection black box system 100 may comprise the steps of: step one, installing ejection protection black box assembly 110 to host aircraft 102; step two, testing black box 120; step three, activating ejection protection black box assembly 110 upon malfunction of host aircraft 102; and recovering ejection protection black box assembly 110 remote from a crash position of host aircraft 102 for analysis.

It should be noted that the steps described in the method of use can be carried out in many different orders according to user preference. The use of “step of” should not be interpreted as “step for”, in the claims herein and is not intended to invoke the provisions of 35 U.S.C. § 112 (f). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An ejection protection black box system comprising:
an ejection protection black box assembly including;
a black box;
a parachute assembly having;
a canopy; and
a plurality of suspension lines;
at least one powerer; and
a motor;
wherein said ejection protection black box assembly comprises in functional combination said black box removably couplable to said parachute assembly, said at least one powerer, and said motor in functional combination;
wherein said parachute assembly comprises said canopy connected to said plurality of suspension lines, said plurality of suspension lines connecting to said black box;
wherein said at least one powerer, and said motor are coupled under said canopy;
wherein said parachute assembly is packed during a non-use condition and deployed when an in-use condition;
wherein said parachute assembly is configured to slow motion of said ejection protection black box assembly when in said in-use condition after being ejected from a host aircraft; and
wherein said ejection protection black box assembly is in wired communication with computers of said host aircraft before ejection, said ejection prompted by a signaled communication of a threshold being reached by said host aircraft, said ejection protection black box assembly when ejected able to safely land a distance separate from said host aircraft should host aircraft crash said ejection protection black box assembly is preserved for review.

2. The ejection protection black box system of claim 1 wherein said threshold being reached by said host aircraft is related to a measure of a sensed malfunction.

3. The ejection protection black box system of claim 1 wherein said ejection protection black box assembly is structured, arranged and equipped to detect approaching missiles.

4. The ejection protection black box system of claim 1 wherein said ejection protection black box assembly is structured, arranged and equipped to detect bombs brought on board said host aircraft.

5. The ejection protection black box system of claim 1 wherein said ejection protection black box assembly comprises a beacon.

6. The ejection protection black box system of claim 5 wherein said black box is sealed to be waterproof.

7. The ejection protection black box system of claim 6 wherein said black box is fireproof.

8. The ejection protection black box system of claim 7 wherein said host aircraft comprises an ejection-port.

9. The ejection protection black box system of claim 8 wherein said ejection-port is located adjacent an exterior of said host aircraft.

10. The ejection protection black box system of claim 9 wherein said ejection-port is a trap door located on a bottom side of said host aircraft.

11. The ejection protection black box system of claim 2 wherein said sensed malfunction is sensed via at least one sensor.

12. The ejection protection black box system of claim 11 wherein said at least one sensor measures cabin pressure of said host aircraft.

13. The ejection protection black box system of claim 11 wherein said at least one sensor measures a sudden drop in elevation of said host aircraft.

14. The ejection protection black box system of claim 11 wherein said at least one sensor measures a sudden drop in oil pressure of said host aircraft.

15. The ejection protection black box system of claim 11 wherein said at least one sensor measures a sudden temperature increase of said host aircraft.

16. The ejection protection black box system of claim 11 wherein said at least one sensor measures a sudden momentum decrease of said host aircraft.

17. The ejection protection black box system of claim 1 wherein said powered comprises a battery which is rechargeable.

18. The ejection protection black box system of claim 11 wherein said black box is remotely located from said host aircraft after said host aircraft once ejection is caused by said at least one sensor.

19. An ejection protection black box system comprising:
an ejection protection black box assembly including;
a black box;
a parachute assembly having;
a canopy; and
a plurality of suspension lines;
a beacon;
at least one powered comprising a battery; and
a motor;
wherein said ejection protection black box assembly comprises in functional combination said black box removably couplable to said parachute assembly, said at least one powerer, and said motor in functional combination;
wherein said parachute assembly comprises said canopy connected to said plurality of suspension lines, said plurality of suspension lines connecting to said black box;
wherein said black box is sealed to be waterproof and fireproof;
wherein said at least one powerer, and said motor are coupled under said canopy;
wherein said battery is rechargeable;
wherein said parachute assembly is packed during a non-use condition and deployed when an in-use condition;
wherein said parachute assembly is configured to slow motion of said ejection protection black box assembly when in said in-use condition after being ejected from a host aircraft;
wherein said host aircraft comprises an ejection-port;
wherein said ejection-port is located adjacent an exterior of said host aircraft;
wherein said ejection-port is a trap door located on a bottom side of said host aircraft;
wherein said ejection protection black box assembly is in wired communication with computers of said host aircraft before ejection, said ejection prompted by a signaled communication of a threshold being reached by said host aircraft, said ejection protection black box assembly when ejected able to safely land a distance separate from said host aircraft should host aircraft crash said ejection protection black box assembly is preserved for review;
wherein said threshold being reached by said host aircraft is related to a measure of a sensed malfunction;
wherein said sensed malfunction is sensed via at least one sensor; and
wherein said black box is remotely located from said host aircraft after said host aircraft once ejection is caused by said at least one sensor.
